(19) United States
(12) Patent Application Publication
(10) Pub. No.: US 2016/0041090 A1
(43) Pub. Date: Feb. 11, 2016

(54) METHOD FOR MANUFACTURING FILM, FILM-MANUFACTURING PROCESS MONITOR DEVICE, AND METHOD FOR INSPECTING FILM

(71) Applicant: SUMITOMO ELECTRIC INDUSTRIES, LTD., Osaka (JP)

(72) Inventors: Akinori KIMURA, Yokohama-shi (JP); Tetsu MORISHIMA, Yokohama-shi (JP); Masumi ITO, Yokohama-shi (JP); Hiroshi SUGANUMA, Yokohama-shi (JP)

(21) Appl. No.: 14/776,493

(22) PCT Filed: Mar. 3, 2014
(86) PCT No.: PCT/JP2014/055223

§ 371 Date: Sep. 14, 2015

(30) Foreign Application Priority Data
Mar. 15, 2013 (JP) 2013-053267

(51) Int. Cl. G01N 21/3563; G01N 21/359; B05D 3/06; G01N 21/84

(52) U.S. Cl. CPC G01N 21/3563; G01N 21/8422; G01N 21/359; B05D 3/067; G01N 2201/061

(57) ABSTRACT

A film production method that includes inspecting the film is provided. The inspection includes a spectrum acquisition step and a physical-quantity calculation step. In the spectrum acquisition step, a film that is moved in direction A is irradiated with broadband light in a near infrared region, and diffuse reflected light emitted from the film is received by a light receiving unit, so that a spectrum of the diffuse reflected light is acquired by a spectrum acquisition unit of an analysis unit. In the physical-quantity calculation step, a physical quantity of the film is calculated from the acquired spectrum of the diffuse reflected light. Since the physical quantity can be determined by acquiring the spectrum, the characteristics of the film can be easily determined. In addition, a plurality of pieces of information can be acquired from the spectrum. Therefore, the characteristics of the film can be more accurately determined.

### TECHNICAL FIELD

The present invention relates to a film production method, a film-production-process monitor, and a film inspection method.

### BACKGROUND ART

A known method for determining characteristics of a film is to irradiate the film with light from a light source, measure the light that is reflected or transmitted by the film, and calculate a physical quantity for determining the desired characteristics based on information regarding the intensity of the reflected or transmitted light. For example, Japanese Unexamined Patent Application Publication No. 2008-157634 describes a method for determining a cure degree of a resin sheet material based on the intensity of transmitted or reflected light obtained by successively irradiating the resin sheet material with infrared light beams in wavelength bands including absorption wavelengths for functional groups of the resin material sheet. With this method, to obtain the physical quantity of a specific portion of the resin sheet material, it is necessary to move infrared-light emitting means and infrared-light receiving means and repeat the measurement of the specific portion a plurality of times while switching among a plurality of filters having different transmission wavelengths. In such a system, the operation of obtaining the physical quantity for determining the characteristics of the filter is complex, and it is difficult to monitor, for example, a film production process in real time.

### SUMMARY OF INVENTION

### Technical Problem

An object of the present invention is to provide a film production method, a film-production-process monitor, and a film inspection method with which characteristics of a film can be easily and accurately determined.

### Solution to Problem

To achieve the above-described object, a film production method including a spectrum acquisition and a physical-quantity calculation step is provided. The spectrum acquisition step includes irradiating a film that is moved with broadband light in a near infrared region and acquiring a spectrum of reflected light or transmitted light emitted from the film. The physical-quantity calculation step includes calculating a physical quantity related to the film from the spectrum.

The film production method according to the present invention may further includes feedback controlling a production condition of the film based on the physical quantity calculated in the physical-quantity calculation step so that the physical quantity is within a predetermined range. The spectrum acquisition step may include acquiring a plurality of the spectrums over time, and the physical-quantity calculation step may include calculating a variation in the physical quantity related to the film over time based on a variation in the spectrums over time. Furthermore, the broadband light may be light having a bandwidth of 25 nm or more. In the present application, the bandwidth is defined as “full width at half maximum”.

According to another embodiment for achieving the above-described object, a film-production-process monitor includes a light source unit, a spectral unit, a light receiving unit, a spectrum acquisition unit, and a physical-quantity calculation unit is provided. A light source unit is configured to irradiate a film that is moved with broadband light in a near infrared region. A spectral unit is configured to divide reflected light or transmitted light emitted from the film as a result of the irradiation of the film with the broadband light from the light source unit, into spectral components. A light receiving unit includes a plurality of light receiving elements configured to receive the spectral components of respective wavelengths divided from each other by the spectral unit and to output signals corresponding to intensities of the received spectral components. A spectrum acquisition unit is configured to acquire a spectrum of the film based on the signals output by the light receiving unit. A physical-quantity calculation unit configured to calculate a physical quantity related to the film from the spectrum acquired by the spectrum acquisition unit.

In the film-production-process monitor according to the present invention, the spectral unit may be a transmission spectral element configured to divide the reflected light or the transmitted light emitted from the film into the spectral components by transmitting the reflected light or the transmitted light. Each of the light receiving elements may include InGaAs and has a quantum well structure. The light receiving elements may be arranged two-dimensionally in the light receiving unit. The spectral unit and the light receiving unit may include an imaging spectroscope configured to detect a spectrum by receiving measurement light on a straight line extending in a direction that crosses a direction in which the film is moved and dividing the measurement light into spectral components.

According to another embodiment for achieving the above-described object, a film inspection method includes a spectrum acquisition step and a physical-quantity calculation step is provided. The spectrum acquisition step includes irradiating the film with broadband light in a near infrared region; and acquiring a spectrum of reflected light or transmitted light that is emitted from a film. The physical-quantity calculation step includes calculating a physical quantity related to the film from the spectrum acquired in the spectrum acquisition step.

### Advantageous Effects of Invention

The present invention provides a film production method, a film-production-process monitor, and a film inspection method with which characteristics of a film can be easily and accurately determined.

### BRIEF DESCRIPTION OF DRAWINGS

FIG. 1 illustrates the structure of a film-production-process monitor according to an embodiment of the present invention.

FIG. 2 illustrates the structure of a film-production-process monitor according to another embodiment of the present invention.

FIG. 3 is a graph showing the second-order differential of a reflectance spectrum in a near infrared wavelength band measured with the film-production-process monitor illustrated in FIG. 1.

FIG. 4 is an enlarged graph showing a portion of the graph of FIG. 3 in a wavelength range of 2100 nm to 2200 nm.

FIG. 5 is a graph showing the relationship between the extreme value of second-order differentiation of the reflectance spectrum in a wavelength range around 2160 nm in the spectrum illustrated in FIGS. 3 and 4 and the Young's modulus of a UV-cured resin.

FIG. 6 is a conceptual diagram illustrating an example of an arrangement of a film-production-process monitor in the case where UV light sources are arranged in a width direction.

### DESCRIPTION OF EMBODIMENTS

Embodiments of the present invention will now be described in detail with reference to the accompanying drawings. In the description of the drawings, the same components are denoted by the same reference numerals, and redundant explanations are thus omitted.

### Film-Production-Process Monitor

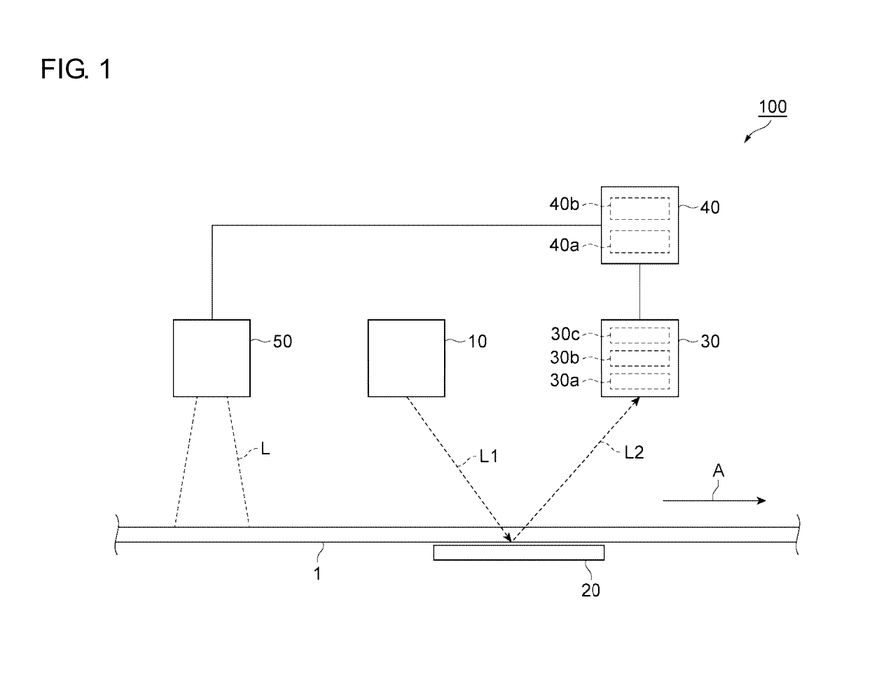

FIG. 1 illustrates the structure of a film-production-process monitor 100 according to an embodiment of the present invention. The monitor 100 irradiates a film 1 that is moved in direction A with broadband light, which is near infrared light, detects diffuse reflected light emitted from the film 1 with a detection unit 30, and calculates a physical quantity that indicates characteristics of the film 1. The monitor 100 includes a light source 10, a diffuse reflectance plate 20, the detection unit 30, and an analysis unit 40.

In a production line of a film having an ultraviolet (UV) cured resin applied thereto, a UV light source unit 50 that is connected to the analysis unit 40 is disposed upstream of the film-production-process monitor 100 in the movement direction A of the film 1. The cure degree of the UV-cured resin on a principal surface of the film is evaluated by the monitor 100, and feedback control of the ultraviolet light source used to cure the UV-curable resin is performed based on the result of the evaluation. The film 1 has the UV-cured resin applied thereto, and a physical quantity used to evaluate the cure degree of the UV-cured resin is, for example, the Young's modulus.

The light source 10 irradiates the film that is moved in direction A with the broadband light, which is near infrared light having a certain wavelength band. The broadband light emitted from the light source 10 is in a wavelength range of 800 to 2500 nm. In the present embodiment, the measurement is preferably performed in a wavelength band including 2160 nm. However, the wavelength range may be changed as appropriate in accordance with the physical quantity that indicates the characteristics of the film 1. A halogen lamp, for example, is appropriate for use as the light source 10.

The broadband light emitted by the light source 10 is light having a bandwidth of at least 25 nm or more. When the bandwidth of the broadband light emitted from the light source 10 is 25 nm or more, a spectrum for accurately calculating one or more physical quantities that indicate the characteristics of the film 1 can be obtained. The bandwidth of the broadband light is preferably at least 50 nm or more.

The diffuse reflectance plate 20 is provided at a side of the film 1 opposite to the side at which the light source 10 is provided (at the backside). Broadband light L1 is emitted from the light source 10, passes through the film 1, and then is diffused and reflected by the diffuse reflectance plate 20, so that diffuse reflected light L2 is incident on the detection unit 30. In the case where light that is regularly reflected by a surface of the film 1 is directly detected by the detection unit 30, the anomalous dispersion effect of the refractive index occurs such that the refractive index varies by a large amount around the peak in a wavelength band in which absorption occurs. Accordingly, the peak is distorted in the first-order differential form, and it is difficult to perform the subsequent spectrum analysis. Therefore, the diffuse reflected light from the diffuse reflectance plate 20 is preferably detected.

The detection unit 30 includes a slit 30a, a spectral unit 30b, and a light-receiving-element unit (light receiving unit) 30c. The diffuse reflected light L2 passes through the slit 30a and enters the spectral unit 30b. The spectral unit 30b divides the diffuse reflected light L2 into spectral components in a direction perpendicular to the longitudinal direction of the slit 30a. The spectral components are received by the light-receiving-element unit 30c.

There is no particular limitation regarding a spectral element included in the spectral unit 30b. However, the spectral element is preferably a transmission spectral element. The transmission spectral element has a higher throughput compared to that of a reflection spectral element, and is therefore suitable for real-time measurement to be applied to an apparatus for producing the film 1.

The light-receiving-element unit 30c includes a plurality of light receiving elements that are two-dimensionally arranged, and each light receiving element receives light. Thus, each light receiving element receives a light component of a corresponding wavelength included in the diffuse reflected light L2 that is reflected at the film 1. Each light receiving element outputs a signal corresponding to the intensity of the received light as two-dimensional information including position information and wavelength information. Since the light receiving elements are two-dimensionally arranged, the physical quantity of the film can be determined at corresponding positions on the film, and the characteristics of the film can be determined more accurately.

Although there is no particular limitation regarding the light receiving elements, in the case where the cure degree of a UV-cured resin is to be evaluated, elements containing InGaAs and having a quantum well structure are preferably used as the light receiving elements. Such a light receiving element has a high sensitivity in a broad near infrared wavelength band, and therefore a high-accuracy measurement can be performed.

The signal output from the detection unit 30 is transmitted to the analysis unit 40. The analysis unit 40 analyzes the signal output from the detection unit 30, calculates the physical quantity that indicates the characteristics of the film 1, and evaluates the state (for example, UV curing state) of the film 1.

The analysis unit 40 includes a spectrum acquisition unit 40a and a physical-quantity calculation unit 40b. The spectrum acquisition unit 40a acquires a spectrum of the diffuse reflected light L2 based on the signal input from the detection unit 30. The physical-quantity calculation unit 40b stores, for example, the relationship between the peak value of the spectrum at a specific wavelength and the physical quantity (for example, Young's modulus) in advance, and determines the physical quantity corresponding to the peak value of the spectrum at the specific wavelength obtained by analyzing the spectrum acquired by the spectrum acquisition unit 40a.

There is no particular limitation regarding the method for analyzing the spectrum, and the spectrum may be subjected to, for example, second-order differentiation, multivariate analysis, or standard normal variate transformation. In the case where the multivariate analysis is performed, characteristics of a plurality of physical quantities can be accurately determined. The standard normal variate transformation is particularly effective for elimination of the influence of baseline variation in the spectrum. Therefore, even when the baseline variation occurs, high-accuracy analysis can be carried out by performing the standard normal variate transformation.

The physical-quantity calculation unit 40b determines whether the calculated physical quantity is within a predetermined range. When the calculated physical quantity is out of the predetermined range, the UV light source unit 50 is subjected to feedback control so that the physical quantity is within the predetermined range. In the case where feedback control of the production conditions is performed so that the physical quantity is within the predetermined range, the film is produced while the production conditions are adjusted in accordance with the physical quantity. Accordingly, a film having uniform characteristics can be produced.

The UV light source unit 50 changes irradiation conditions of the UV light source unit 50 in accordance with the feedback control performed by the analysis unit 40, and irradiates the film 1 with UV light L. The calculation of the physical quantity is also performed for the film 1 produced after the irradiation conditions of the UV light source unit 50 have been changed, and it is determined whether the calculated physical quantity is within the predetermined range. When the calculated physical quantity is within the predetermined range, the current production conditions are continuously used. When the physical quantity is outside the predetermined range, the feedback control is performed again so that the irradiation conditions of the UV light source unit 50 are changed.

To perform the feedback control, the spectrum acquisition unit 40a may acquire a plurality of spectrums of the film 1 over time, and, in a physical-quantity calculation step performed by the physical-quantity calculation unit 40b, a variation in the physical quantity related to the film may be calculated on the basis of a variation in the spectrums over time. The feedback control may be performed on the thus-obtained calculation result. In this case, variation in the physical quantity over time along the direction in which the film is moved can be determined. Accordingly, the production state can be determined even when, for example, the production state changes over time.

As described above, a method for producing the film 1 by using the film-production-process monitor 100 includes a spectrum acquisition step of irradiating the film 1 that is moved with the broadband light L1, which is near infrared light, and acquiring the spectrum of the diffuse reflected light L2 emitted from the film 1, and a physical-quantity calculation step of calculating the physical quantity related to the film 1 from the acquired spectrum of the diffuse reflected light L2. With this method, the physical quantity that indicates the characteristics of the film 1 can be obtained by acquiring the spectrum, and therefore the characteristics of the film can be easily determined. Furthermore, since a plurality of pieces of information can be acquired from the spectrum, the characteristics of the film can be accurately determined, and the film can be produced based on the acquired information.

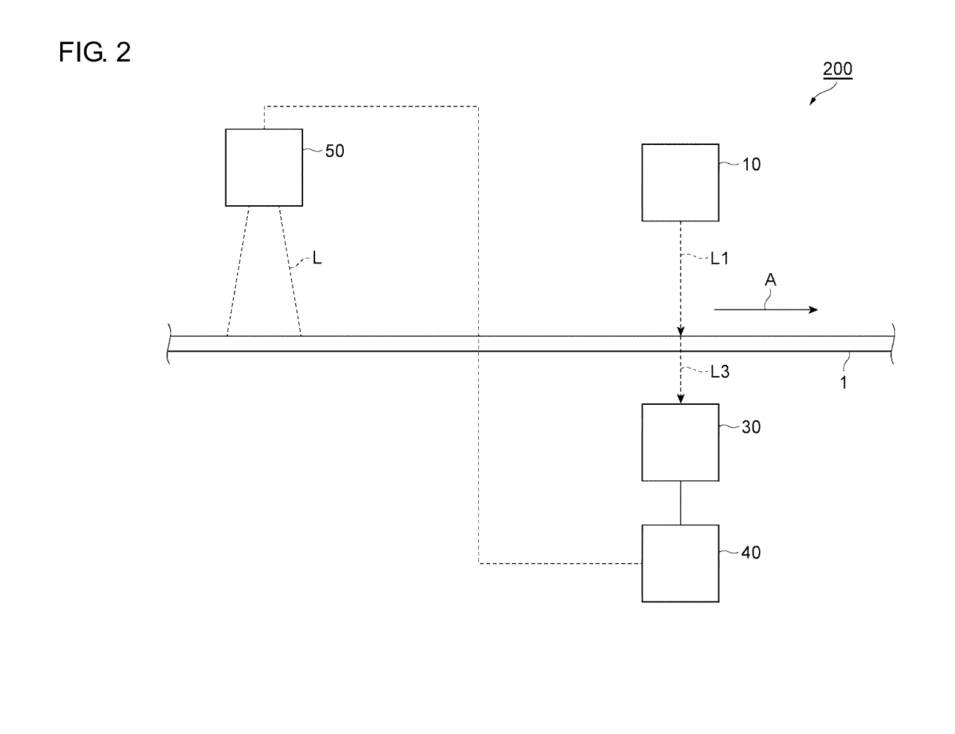

FIG. 2 is a schematic diagram illustrating the structure of a film-production-process monitor 200 according to another embodiment of the present invention. The film-production-process monitor 200 differs from the production-process monitor 100 in that after the film 1 that is moved in direction A is irradiated with broadband light, which is near infrared light, transmitted light L3 is detected by the detection unit 30. Therefore, it is not necessary that the film-production-process monitor 200 include the diffuse reflectance plate 20.

The detection unit 30 is located so as to oppose the light source 10 with the film 1 disposed therebetween. Part of the broadband light, which is near infrared light, emitted from the light source 10 is transmitted through the film 1. The transmitted light passes through the slit 30a in the detection unit 30, is divided into spectral components by the spectroscope 30b, and then is received by the light-receiving-element unit 30c. After that, similar to the case of the film-production-process monitor 100, the spectrum is acquired, and the physical quantity is calculated and evaluated. Thus, the transmitted light L3 may be used to calculate the physical quantity that indicates the characteristics of the film 1.

### Application Example for Controlling Production Conditions in Film Production

Here, an example in which a cure degree of a film having a UV-cured resin applied thereto is measured by using the film-production-process monitor 100 will be described to show that the film-production-process monitor according to the present invention is suitable for use as a process monitor for a film production method.

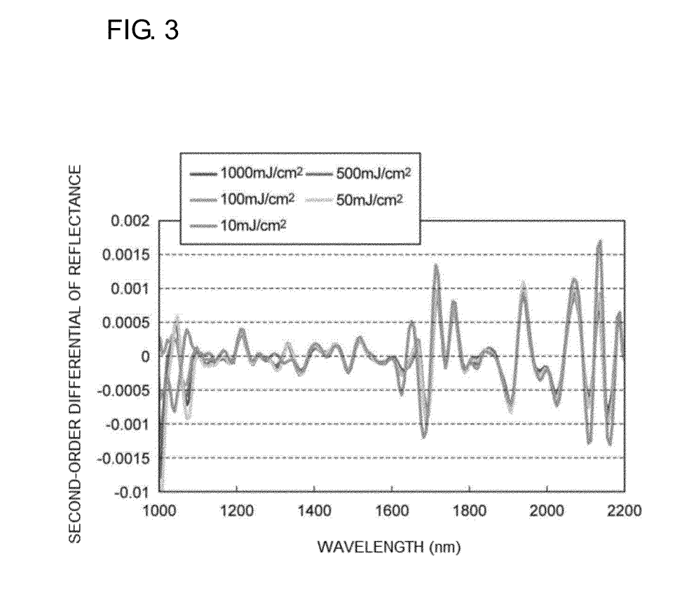

FIG. 3 is a graph showing the second-order differential of a reflectance spectrum in a near infrared wavelength band. For each of PET films having a uniform UV-cured resin layer on one surface thereof and irradiated with UV light with an amount of irradiation of 10 mJ/cm², 50 mJ/cm², 100 mJ/cm², 500 mJ/cm², and 1000 mJ/cm², the spectrum (in a wavelength range of 1000 nm to 2400 nm) of the diffuse reflected light was acquired by using the film-production-process monitor 100. The acquired spectrum was used to calculate a reflectance spectrum, and then second-order differentiation of the reflectance spectrum was performed to obtain the second-order differential reflectance spectrum. FIG. 3 shows the thus-obtained second-order differential reflectance spectrum.

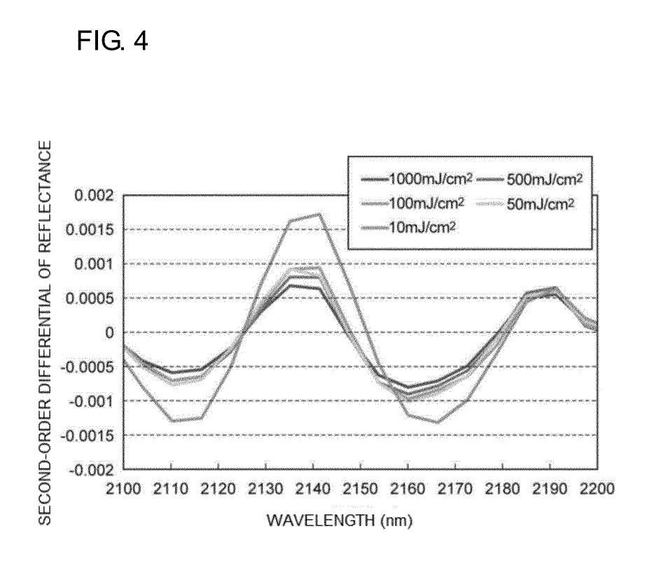

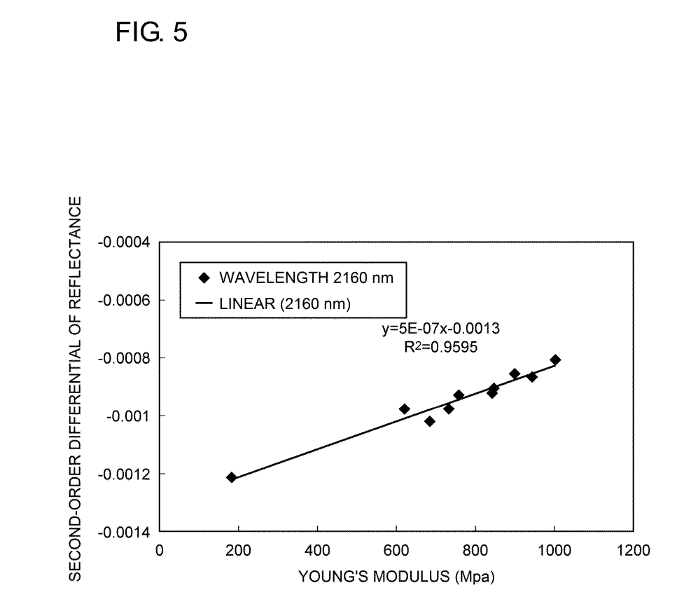

FIG. 4 is enlarged graph which shows a portion of FIG. 3 in a wavelength range of 2100 nm to 2200 nm. FIG. 5 shows the extreme value of second-order differentiation of the reflectance spectrum at a wavelength around 2160 nm in the spectrum illustrated in FIGS. 3 and 4 with respect to the measurement result of the Young's modulus of the UV-cured resin. FIG. 5 shows the results of measurements of a plurality of films having UV-cured resin applied thereto that were irradiated with UV light with different amounts of irradiation in addition to those of the films having UV-cured resin applied thereto that were used to measure the second-order differential reflectance spectrum illustrated in FIGS. 3 and 4. Therefore, the number of samples is increased.

As is clear from FIGS. 3 and 4, a peak (second-order differentiation extreme value) that is correlated with a physical property value of the resin, whose cure degree is expected to increase as a result of irradiation with the UV light, is around a wavelength of 2160 nm. As is clear from FIG. 5, the peak around the wavelength of 2160 nm correlates with the Young's modulus, which indicates the cure degree of the UV-cured resin.

The peak at a wavelength around 2160 nm varies owing to the curing reaction of the UV-cured resin. Therefore, by using the correlation between the second-order differential and the Young's modulus in this wavelength band, the cure degree of the UV-cured resin can be determined by using the spectrum obtained by the film-production-process monitor 100.

For example, when the second-order differential at the wavelength around 2160 nm is reduced in a certain region of the film 1 during production, it can be assumed that the actual amount of irradiation has decreased from the set value due to degradation of a UV lamp, or that the UV lamp has gone out. In the case where the amount of irradiation has decreased, feedback control of an operation unit (not shown) that controls the output of the UV lamp may be performed so as to compensate for the decrease in the amount of light. In the case where the UV lamp has gone out, it can be assumed that the UV resin is hardly cured because the UV lamp does not emit light. Therefore, it can be assumed that the second-order differential drops rapidly. Accordingly, if such a variation in physical quantity over time is detected, a message requesting a replacement of the lamp may be presented. Thus, the occurrence of UV curing failure due to a trouble regarding the UV light source unit 50 can be greatly reduced.

Furthermore, the film production process includes the steps of mixing and agitating the materials of the film, extruding the mixture with an extruder, and then performing, for example, an elongating process and a coating process. In these steps, whether the state of the film is maintained uniform in the longitudinal direction (direction A in FIG. 1) is important from the viewpoint of quality management.

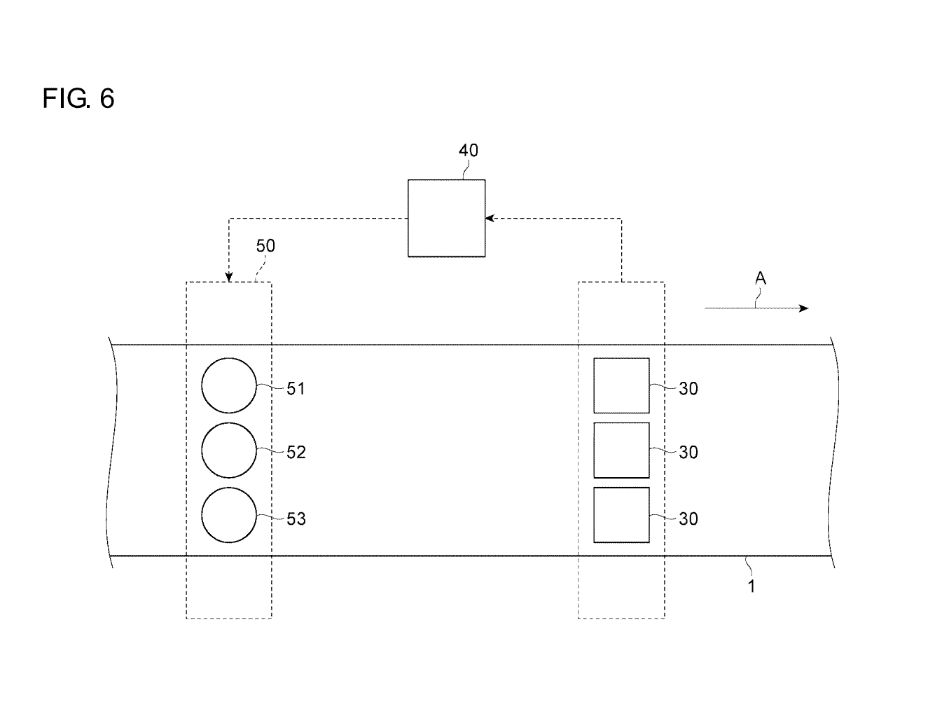

In general, in a production line of a film having UV-cured resin applied thereto, a plurality of UV lamps are arranged in a width direction of a film that is several meters wide. For example, FIG. 6 illustrates a UV light source unit 50 including three UV light sources 51 to 53 that are arranged in the width direction (direction orthogonal to direction A).

Since the cure degree of UV resin depends on the amount of irradiation of the UV resin, when the cure degree is to be uniform over the entire area of the film 1, it is necessary to manage the UV lamps 51 to 53 so that output intensities thereof are constant. More specifically, preferably, the UV lamps 51 to 53 have the same output intensity, and the output intensity is constant over time while the film 1 is being moved.

However, in practice, the irradiation intensities of the UV lamps 51 to 53 are not uniform in the irradiation regions thereof. In addition, the lamps have individual differences, and the irradiation intensities thereof vary with time. Therefore, to appropriately evaluate and manage the UV cure degree, it may not be sufficient to control the irradiation conditions of the UV lamps 51 to 53 based on the result of the measurement of the UV light intensity at a single point in the area irradiated with light from the UV lamps 51 to 53.

Accordingly, as illustrated in FIG. 6, a plurality of film-production-process monitors, the number of which corresponds to the number of UV lamps, are arranged in the width direction. The cure degree of the film that is irradiated with the UV light is evaluated in real time, and feedback control is performed based on the result of the evaluation. Accordingly, the cure degree of the film can be maintained uniform in the planar direction. In this case, light that enters the spectral unit 30b included in each of the three detection units 30 is divided into spectral components, and the spectral components are received by the corresponding light-receiving-element unit 30c.

In the case where the film-production-process monitor according to the present embodiment is applied to a production process of a film having UV-cured resin applied thereto, feedback control of parameters such as the irradiation intensity of the UV lamp and the line movement speed may be performed on the basis of the film thickness, mixing ratio, etc., in addition to the cure degree. In such a case, a production line in which the occurrence of failure is reduced can be realized. In this case, the physical quantities, such as the film thickness and mixing ratio, may be calculated from the spectrum acquired as in the above-described embodiment, and the feedback control may be performed based on the result of the calculation.

### Application Example for Managing Aggregation of Specific Component in Film Production

In a film production process, additives, such as a plasticizer or a cross linking agent, are often added to impart various functions to the film. Ideally, these additives are sufficiently agitated and mixed with other materials, and are uniformly dispersed in the film that is produced. However, some types of additives may have a melting point or a moisture absorbency such that they aggregate in local regions during the production process depending on, for example, the temperature or humidity. In the case where the additives aggregate in local regions, the produced film may include random spots where the concentration of a certain component differs from that in other regions. In such a case, the final product will be defective. Therefore, the aggregation in local regions is undesirable from the viewpoint of production efficiency.

In the case where a specific component aggregates in a certain region, since the content of that component is high in that region, the spectrum intensity in a specific wavelength band in that region differs from that in other regions depending on the component. Accordingly, the spectrum of the film in the wavelength band corresponding to the specific component is acquired by the film-production-process monitor 100, and the amount of the specific component (degree of aggregation) is calculated as a physical quantity from the acquired spectrum. Thus, the degree of aggregation of the specific component can be determined, and feedback control of means for managing the process temperature and humidity can be performed based on the degree of aggregation. In this case, the occurrence of failure due to the aggregation of the specific component can be reduced, and the productivity can be increased.

### Application Example for Managing Multilayer Film Thickness in Film Production

In general, a multilayer film is a film formed by stacking a plurality of types of films on a first film that serves as a base material or forming a protective film on the first film so that the multilayer film has optical characteristics such as polarizability or a protecting performance such as gas barrier characteristics. To achieve a predetermined performance, it is necessary to constantly monitor whether the thickness of each of the layers that are stacked together is within a predetermined range in the production process. In a film thickness measurement system according to the related art, the measurement is performed at a single point or a plurality of points in the short-side direction of the film. However, by using the method of the present embodiment, the thickness of each layer can be managed over the entire region in the short-side direction of the film.

In this case, the spectrum of each of the layers included in the multilayer film at a certain thickness needs to be measured in advance. Based on the thus-obtained spectral data, a wavelength corresponding to a characteristic spectral component is determined for each layer, and variation in the value for each film thickness at that wavelength is recorded. These values are used to analyze the spectrum of the multilayer film in the production process, and variation in the value corresponding to the wavelength for each layer is monitored. When an abnormal value is detected, feedback control of the process for the corresponding layer is performed. Thus, a multilayer film including layers having a uniform thickness can be produced at a high yield.

### Application Example for Inspection of Produced Film

A film product that has been produced may be degraded or degenerated due to various factors, such as ambient temperature, humidity, and ambient light while the film product is stored. Also in this case, the film can be inspected by using the film-production-process monitor 100 according to the above-described embodiment.

In the case where the film-production-process monitor 100 is used outside the production line, the relationship between the physical quantity related to the film product and information that can be obtained from the spectrum acquired by irradiating the film with the broadband light, which is near infrared light, is obtained in advance. Then, the spectrum of the film product that has been produced, which is the object to be inspected, is acquired. Whether the film product is good is determined based on whether the physical quantity determined from the spectrum is within a predetermined range.

According to the above-described method, defective products can be detected in a non-contact and non-invasive manner. Similar to the case in which the film production process is monitored in the production line as in the above-described embodiment, when the inspection is performed while the film product is being moved, total inspection can be performed easily and quickly, and it is possible to remove only the defective portions.

Foreign matter that has been mixed into the film inside or outside the production process can also be detected by the inspection method using the film-production-process monitor 100 according to the above-described embodiment. More specifically, the above-described inspection method is effective for detection of foreign matter with which spectrum having characteristics different from those of the spectrum of the film of good quality can be obtained.

In the case where the characteristics of the foreign matter that is mixed into or attached to the film product greatly differ from those of the film, it can be assumed that there is a large difference between the spectrum of a good-quality product and that of a film product that is inspected. Therefore, it can be assumed that the physical quantity that indicates the characteristics of the foreign matter can be determined by calculating, for example, the difference or ratio between the spectrums. In contrast, in the case where the characteristics of the foreign matter are similar to those of the film product as in the case of, for example, a resin that differs from the resin included in the product, there is a possibility that the spectrum of a good-quality product and the spectrum of the film product that is inspected are similar to each other. In such a case, multivariate analysis, for example, is performed to calculate the physical quantity of the foreign matter.

The present invention is not limited to the above-described embodiments, and various modifications are possible. For example, in the above-described embodiments, a halogen lamp is used as the light source 10. However, a super continuum (SC) light source, for example, may instead be used. Alternatively, a laser light source that outputs near infrared light in a specific wavelength band may instead be used.

In FIG. 6, three detection units 30 are arranged in the width direction of the film (direction orthogonal to direction A, which is the movement direction). However, it is not necessary that the detection units 30 be arranged in the width direction as long as a plurality of detection units 30 are arranged in a direction that crosses direction A. In such a case, the spectrum can be acquired at a plurality of positions that are arranged in a direction that crosses the movement direction and that are separated from each other in the width direction of the film, and the production process can be appropriately monitored.

Furthermore, in a single film-production-process monitor, the spectral unit 30b and the light receiving unit 30c may be an imaging spectroscope that detects a spectrum by receiving measurement light on a straight line that extends in a direction that crosses the movement direction of the film and dividing the measurement light into spectral components. In this case, the spectrum can be acquired at each position on the straight line that extends in the direction that crosses the movement direction of the film. Accordingly, the measurement of the film can be performed more precisely, and the characteristics of the film can be determined more accurately.

1. A film production method comprising:
a spectrum acquisition step comprising
irradiating a film that is moved with broadband light in a near infrared region, and
acquiring a spectrum of reflected light or transmitted light emitted from the film; and
a physical-quantity calculation step comprising calculating a physical quantity related to the film from the spectrum.

2. The film production method according to claim 1, further comprising feedback controlling a production condition of the film based on the physical quantity so that the physical quantity is within a predetermined range.

3. The film production method according to claim 1, wherein
the spectrum acquisition step comprises acquiring a plurality of the spectrums over time, and
the physical-quantity calculation step comprises calculating a variation in the physical quantity related to the film over time based on a variation in the spectrums over time.

4. The film production method according to claim 1, wherein
the broadband light is light having a bandwidth of 25 nm or more.

5. A film-production-process monitor comprising:
a light source unit configure to irradiate a film that is moved with broadband light in a near infrared region;
a spectral unit configured to divide reflected light or transmitted light emitted from the film as a result of the irradiation of the film with the broadband light from the light source unit, into spectral components;
a light receiving unit including a plurality of light receiving elements configured to receive the spectral components of respective wavelengths divided from each other by the spectral unit and to output signals corresponding to intensities of the received spectral components;
a spectrum acquisition unit configure to acquire a spectrum of the film based on the signals output by the light receiving unit; and
a physical-quantity calculation unit configured to calculate a physical quantity related to the film from the spectrum acquired by the spectrum acquisition unit.

6. The film-production-process monitor according to claim 5, wherein
the spectral unit is a transmission spectral element configured to divide the reflected light or the transmitted light emitted from the film into the spectral components by transmitting the reflected light or the transmitted light.

7. The film-production-process monitor according to claim 5, wherein
each of the light receiving elements includes InGaAs and has a quantum well structure.

8. The film-production-process monitor according to claim 5, wherein,
the light receiving elements are arranged two-dimensionally in the light receiving unit.

9. The film-production-process monitor according to claim 8, wherein
the spectral unit and the light receiving unit comprises an imaging spectroscope configured to detect a spectrum by receiving measurement light on a straight line extending in a direction that crosses a direction in which the film is moved and dividing the measurement light into spectral components.

10. A film inspection method comprising:
a spectrum acquisition step comprising:
irradiating the film with broadband light in a near infrared region; and
acquiring a spectrum of reflected light or transmitted light that is emitted from a film; and
a physical-quantity calculation step comprising calculating a physical quantity related to the film from the spectrum acquired in the spectrum acquisition step.

11. The film production method according to claim 2, wherein
the spectrum acquisition step comprises acquiring a plurality of the spectrums over time, and
the physical-quantity calculation step comprises calculating a variation in the physical quantity related to the film over time based on a variation in the spectrums over time.

12. The film production method according to claim 2, wherein
the broadband light is light having a bandwidth of 25 nm or more.

13. The film production method according to claim 12, wherein
the broadband light is light having a bandwidth of 25 nm or more.

14. The film-production-process monitor according to claim 6, wherein
each of the light receiving elements includes InGaAs and has a quantum well structure.

15. The film-production-process monitor according to claim 6, wherein,
the light receiving elements are arranged two-dimensionally in the light receiving unit.

16. The film-production-process monitor according to claim 15, wherein,
the light receiving elements are arranged two-dimensionally in the light receiving unit.

17. The film-production-process monitor according to claim 14, wherein
the spectral unit and the light receiving unit comprises an imaging spectroscope configured to detect a spectrum by receiving measurement light on a straight line extending in a direction that crosses a direction in which the film is moved and dividing the measurement light into spectral components.

18. The film-production-process monitor according to claim 15, wherein
the spectral unit and the light receiving unit comprises an imaging spectroscope configured to detect a spectrum by receiving measurement light on a straight line extending in a direction that crosses a direction in which the film is moved and dividing the measurement light into spectral components.

19. The film-production-process monitor according to claim 16, wherein
the spectral unit and the light receiving unit comprises an imaging spectroscope configured to detect a spectrum by receiving measurement light on a straight line extending in a direction that crosses a direction in which the film is moved and dividing the measurement light into spectral components.
